(19) United States
(12) Patent Application Publication
(10) Pub. No.: US 2004/0150672 A1
(43) Pub. Date: Aug. 5, 2004

(54) Picture analyzer with a window interface

(76) Inventors: Bozidar Janko, Portland, OR (US); Gale L. Straney, Aloha, OR (US); Kathryn A. Engholm, Beaverton, OR (US)

Correspondence Address: Tektronix, Inc., Francis I. Gray, MS 50-LAW, P.O. Box 500, Beaverton, OR, 97077, US

(21) Appl. No.: 10/355,390

(22) Filed: Jan. 31, 2003

(51) Int. Cl. G09G 5/00

(52) U.S. Cl. 345/804

(57) ABSTRACT

A picture analyzer with a window interface operates on a host processor together with a video image processing or display application. The video image processing or display application provides as part of a first window on a display monitor an image to be analyzed. The picture analyzer captures bitmap data for the image and processes it according to a desired measurement algorithm to produce measurement results. The measurement results are displayed in a second window on the display monitor. The second window also includes controls for the picture analyzer so an operator may interface with the picture analyzer to select the desired measurement algorithm and associated parameters.

### BACKGROUND OF THE INVENTION

The present invention relates to the analysis of video images, and more particularly to a picture analyzer with a window interface.

In the field of creating static or moving video electronic imagery it is common to use image analyzers. In the case of video imagery waveform monitors, vectorscopes, gamut displays, etc. are used. In static imagery people often use color histograms to gain insight into distribution of color in the image. Information derived from using such video analyzers is then used for color correction and verification that image parameters are confined to prescribed ranges. Input to image analyzers is provided generally through a coaxial cable in cases where hardware analyzers are used. In the case of software analyzers the input data is derived either by reading a computer file where the images are stored, or by using an application for editing video which serves image information to the analyzer through an internal link in the computer. In the software analyzer case the analyzer application needs to decode file formats in which the video is encoded, or the editing application needs to be equipped with an appropriate interface to supply data to the analyzer. The problem is that the analyzer software has to be adapted to each individual application depending upon the type of imagery being analyzed.

What is desired is a picture analyzer that may be used to analyze a broad variety of electronic imagery.

### BRIEF SUMMARY OF THE INVENTION

Accordingly the present invention provides a picture analyzer with a window interface that allows the analyzer software to reside in the same computer as other video software applications. The video applications provide as part of a first window on a display monitor an image to be analyzed. The picture analyzer captures bitmap data for the image and processes it according to a desired measurement algorithm to produce measurement results. The measurement results are displayed in a second window on the display monitor. The second window also includes controls for the picture analyzer so an operator may interface with the picture analyzer to select the desired measurement algorithm and associated parameters.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a logic block diagram view of a picture analyzer with a window interface according to the present invention.

FIG. 2 is a plan view of a computer display illustrating the picture analyzer with a window interface according to the present invention.

### DETAILED DESCRIPTION OF THE INVENTION

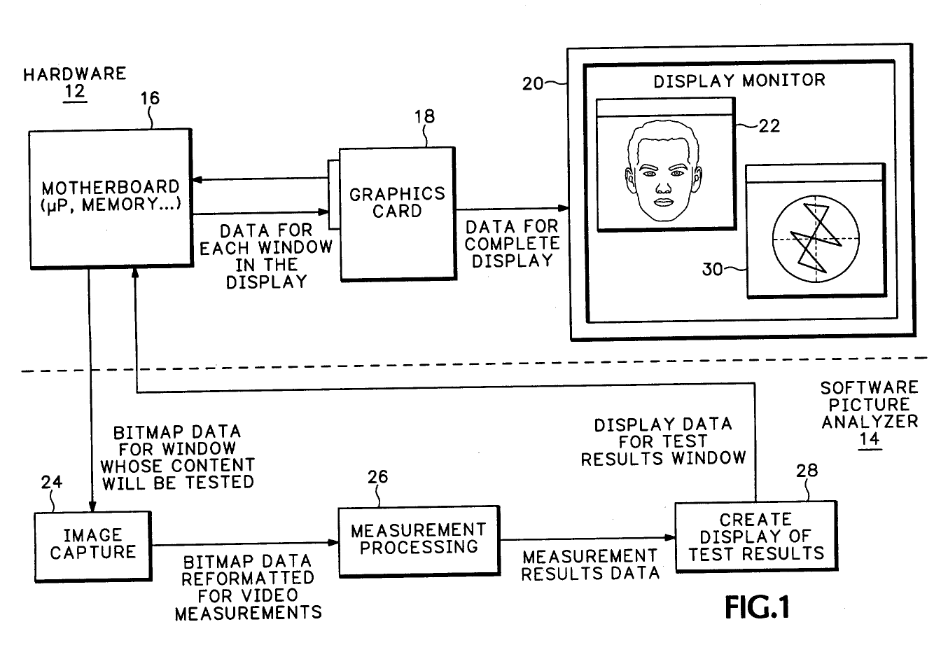

Referring now to FIG. 1 a basic hardware configuration, such as a personal computer (PC), 12 is shown together with a software picture analyzer 14. A conventional motherboard 16, including a host processor, memory, etc., contains video/image data to be tested. The video/image data may be displayed via a graphics card 18 on a display monitor 20 in a first window 22. Bitmap data for the video/image data in the first window 22 is passed to an image capture module 24 in the software picture analyzer 14 which runs on the host processor. The image capture module 24 reformats the bitmap data to make it compatible with various video measurement algorithms, such as waveform, vector, color gamut, etc. The reformatted bitmap data is input to a measurement processing module 26 which applies the appropriate video measurement algorithms, either as manually selected or automatically according to a prescribed instrument setup, to produce measurement results data. The software measurement algorithms test the reformatted bitmap data for compliance with industry standards and to produce quantitative and qualitative representations for the video/image data. The measurement results data is input to a test results display module 28 for conversion into waveforms, graphs, vector diagrams, alarm icons, error listings and other types of visual indicators. The resulting display data is returned to the host processor. The host processor formats the display data into a second window 30 on the display monitor 20.

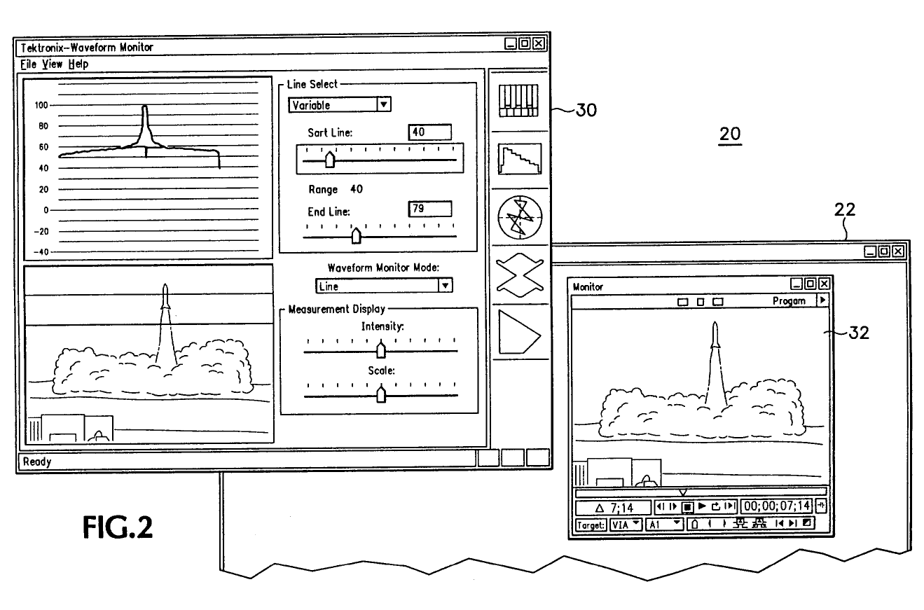

FIG. 2 shows a larger view of the display monitor 20 where a video editing application is running in the first window 22. As part of the video editing application an internal image window 32 is shown. The bitmap data for the image within the internal image window 32 is captured by the software picture analyzer 14 for image analysis, the results of which are shown in the second window 30 which may overlap the first window 22 as shown, or vice versa. The measurement results display data shown in the second window 30 includes controls as well as the measurement images, with the controls being accessible using standard computer interface technology to select the measurement algorithm and parameters. For example controls are shown for Arrowhead, Diamond, vectorscope, waveform and image displays, with waveform being the currently selected measurement algorithm for display.

Thus the present invention provides a picture analyzer with a window interface that may be used with any host processor for providing measurements of video/image data contained within a window interface for another video/image data processing or display software application.

1. A picture analyzer comprising:
means for capturing bitmap data for an image displayed on a display monitor in a first window by a first image application;
means for analyzing the bitmap data to produce desired measurement data; and
means for displaying the desired measurement data within a second window on the display monitor.

2. The picture analyzer as recited in claim 1 wherein the second window comprises interactive controls for the analyzing means to select a measurement algorithm and parameters for use by the analyzing means in producing the desired measurement data.

3. The picture analyzer as recited in claim 2 wherein the second window has a first portion for displaying the desired measurement data and a second portion for displaying the interactive controls.

4. A method of analyzing an image displayed in a first window of a display monitor comprising the steps of:
capturing bitmap data for the image;
analyzing the bitmap data according to a desired measurement algorithm to produce measurement results; and
displaying the measurement results on the display monitor in a second window.

5. The method as recited in claim 4 further comprising the step of including in the second window interactive controls for the analyzing step.

6. The method as recited in claim 5 wherein the second window comprises a first portion for displaying the measurement results and a second portion for displaying the interactive controls.
